(19) United States
(12) Patent Application Publication
(10) Pub. No.: US 2008/0127839 A1
(43) Pub. Date: Jun. 5, 2008

(54) Press with travel controllable drive arrangement

(76) Inventor: Jurgen Fahrenbach, Aichelberg (DE)

Correspondence Address: RONALD S. LOMBARD;PATENTS AND TRADEMARKS, 4430 TWIN OAKS DRIVE, MURRYSVILLE, PA, 15668, US

(21) Appl. No.: 11/986,880

(22) Filed: Nov. 27, 2007

(30) Foreign Application Priority Data
Nov. 30, 2006 (DE) 10 2006 056 520.7

(51) Int. Cl. B30B 1/00

(52) U.S. Cl. 100/214

(57) ABSTRACT

In a press with an adjustable drive arrangement including, in addition to, a main drive, an adjustment drive for dynamically changing the press kinematics of the manually predetermined press angle-plunger stroke. Means are provided, whereby during a transforming process, the speed of a movable plunger of the tool part which engages the workpiece for the transformation thereof, is reduced, essentially to zero, for the moment of engagement between the plunger and the workpiece, so as to provide for a smooth impact force engagement between the plunger and the workpiece.

### CROSS-REFERENCE TO RELATED APPLICATION

This application claims the priority benefits of German Application No. 10 2006 056 520.7 filed Nov. 30, 2006.

### BACKGROUND OF THE INVENTION

The invention relates to a press with a drive arrangement connecting the operating movement of the press plunger.

Press drives, for example, for cutting presses, draw presses, or stamping presses for the deformation of bodies, such as transverse flux presses, often include a lever drive arrangement which generates a travel-time curve which deviates from the normal sine form of movement. Such a lever drive is generally designed to generate near the bottom dead center portion of the plunger movement which flattens the plunger movement curve so as to approach a straight line. To achieve this, various lever kinematics are known in the art.

Furthermore, presses are known which include adjustment mechanisms. DE 695 18 899 T2, for example, discloses a press with an eccentric member which acts on a lever drive. The eccentric member forms a first input for the lever drive whose output is connected to a plunger. A lever, of the lever drive, forms a second input which is connected to an air cylinder. This makes it possible to adjust the lower dead center position of the press plunger.

With the initially presented movement arrangements, the tool has a certain non-negligible speed when hitting the workpiece, which increases as the number of strokes increases. This cases substantial stresses on the tool and a substantial noise in the operation of the tool.

Generally, a plunger movement would be desirable which, with a uniformly running drive source and a lever drive arrangement is difficult to achieve. In addition, the plunger movement should also be adjustable.

To achieve this DE 1982 1159 proposes to drive the plunger by means of several servo-motors. To achieve this, the servo-motors need to generate, on one hand, all the required maximum press force and, on the other hand, need to be able to reach a high adjustment speed. The servo-motors are connected to the plungers by way of spindle stroke drives. If such a drive has a transmission ratio, a high press force can be achieved, but the adjustment speed is relatively low. If it has a low transmission ratio, the achievable adjustment speed is relatively high, but the maximum press force is limited. For achieving high press forces then, very large servo-motors must be used.

It is the object of the present invention, to provide a press with a drive arrangement by which in a simple and energetically advantageous manner variable travel/press-angle arrangements of the press can be achieved.

### SUMMARY OF THE INVENTION

In a press with an adjustable drive arrangement including, in addition to a main drive, an adjustment drive for dynamically changing the press kinematics of the manually predetermined press angle-plunger stroke. Means are provided, whereby, driving a transforming process, the speed of a movable plunger of the tool part which engages the workpiece for the transformation thereof, is reduced, essentially to zero for the moment of engagement between the plunger and the workpiece, so as to provide for a smooth impact force engagement between the plunger and the workpiece.

The first drive input has a uniform drive movement in that it rotates, for example, at essentially a constant speed. The second input of the drive is connected to a second drive source with a modulated drive movement. This means that the drive movement of the second drive source is controllable, that is adjustable in a time-dependent manner. As a result, a second movement is imposed over the movement caused by the first drive source which may be considered a correcting movement. The correcting movement may be used, for example, to slow the movement of the plunger just before it engages the workpiece to such an extent that it contacts the workpiece smoothly. After that, the second drive source again contributes to the acceleration of the plunger.

The second drive source may be a linear drive, an eccentric member drive, a rotational drive, a hydraulic cylinder, a pneumatic cylinder, a servo-drive or any other drive which can be operated in travel distance—controllable manner. In addition, it must be connected to an energy storage device in order to recuperate the energy gained and stored during slowing of plunger movement for again accelerating the plunger. The energy storage device may be a pneumatic pressure store, a spring, a flywheel device or a similar device

The drive is preferably a lever drive which is driven by the first drive source via an eccentric member. In addition, it preferably includes a support point which forms the second input and is connected to the second drive source. The support point may, for example, be the end of a support member of an elbow lever drive.

For the control of the press preferably a control arrangement is provided which controls at least the second drive arrangement, but preferably also the first drive arrangement. By the control of the second drive arrangement, the travel-time curve of the plunger movement can be relatively freely adjusted within given limits. It is, for example, possible to select a certain travel/time curve for the plunger movement. The second drive arrangement may be in a rest position during operation of the press. It is, however, preferred if the second drive arrangement is actively controlled for superimposing another movement on the plunger movement, in order to obtain the desired travel/time curve for the plunger movement.

The second drive source can be controlled dependent on plunger position or on the eccentric member position. The plunger position or eccentric member position can be determined, for example, by means of corresponding sensors. The second drive source can then be operated in accordance with a fixed travel/time profile. For example, the control arrangement includes a certain program via which each eccentric member position is assigned a control position of the second drive source.

But it is also possible to optimize this movement profile depending on the recorded acceleration values. To this end, the plunger and/or the moving part of the tool may be provided with acceleration sensors. Furthermore, the moving tool part, the plunger or another part of the drive may be provided with force sensors in order to determine the point in time when the tool part comes into contact with the workpiece and to change in this way the profile of the movement of the second drive source in such a way that the impulse occurring thereby is minimized.

The invention will become more readily apparent from the following description of preferred embodiments, thereof, on the basis of the accompanying drawings.

### BRIEF DESCRIPTION OF THE DRAWINGS

FIG. 1 shows a press with two drive arrangements in a schematic representation;

FIG. 2 shows a modified embodiment of the press arrangement according to FIG. 1;

FIG. 3 shows another embodiment of the press arrangement according to the invention;

FIG. 4 shows still another embodiment of the press arrangement according to the invention;

FIG. 5 shows diagrammatically a travel/time curve of the plunger movement; and,

FIG. 6 shows a speed/time curve of the plunger movement also in the form of a diagram.

### DESCRIPTION OF THE PREFERRED EMBODIMENTS

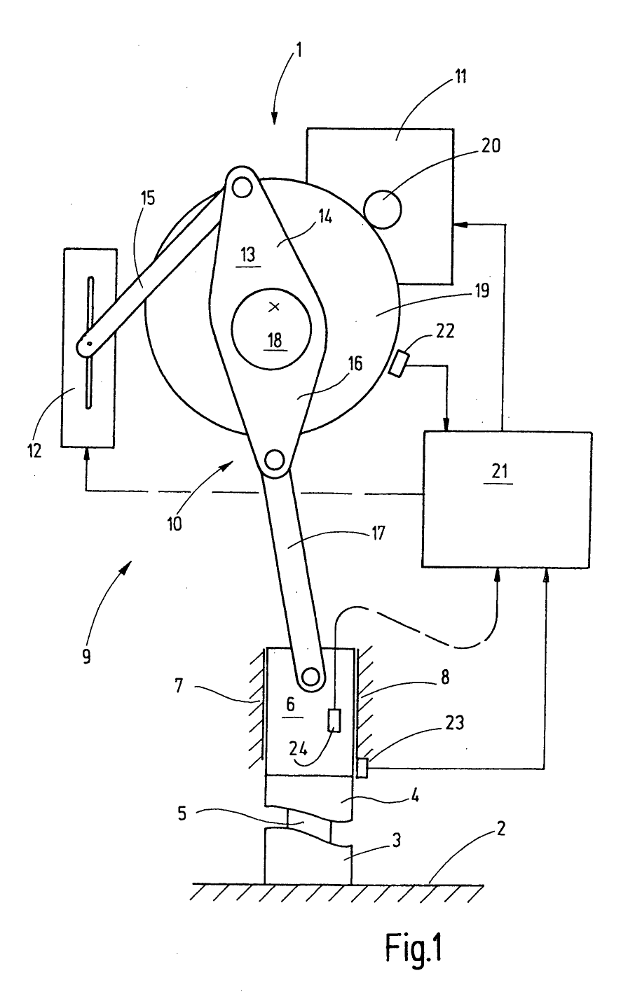

FIG. 1 shows a press 1 in a highly schematic manner. The press 1 includes a press frame which is not fully shown, but which includes a table or a surface 2 for supporting a lower tool part 3. An upper tool part 4 is assigned to the lower tool part 3. Both tool parts 3, 4 serve the transformation of a workpiece 5. The upper tool part 4 is carried by a plunger 6 which is supported so as to be movable linearly in guide tracks 7, 8 which are shown only schematically. In FIG. 1, the plunger 6 is movable vertically up and down so that the upper tool part 4 is movable toward, and away from, the lower tool part 3.

For driving the plunger 6, a plunger drive 9 is provided which, like in the embodiment shown, may be a lever drive 10, a first drive source 11 and a second drive source 12. The lever drive 10 includes in the present embodiment a joint carrier 13 in the form of a double arm lever. The first lever arm 14 is pivotally connected to the second drive source 12 by way of a link 15. The end 15a of the link 15 is pivotally connected to the second drive source 12. The second lever arm 16 is pivotally connected via a second link 17 to the plunger 6. The joint carrier 14 is supported on an eccentric member 18 which forms a first input of the lever drive 10 and is connected with a drive output 20 of the first rotational drive source 11, for example, via a gear 19. The gear 19 may additionally form a flywheel. The drive output 20 may be a spur gear which is in engagement with the gear 19.

The end of 15a of the link 15 which is remote from the lever arm 14 represents a second input of the lever gear 10 which is connected to the second drive source 12. The second drive source 12 may be, for example, a linear drive arrangement by which via an adjustment of the drive source 12 the connecting point of the link 15 is adjustable in the space; particularly with regard to the axis of rotation of the eccentric member 18.

The press 1 preferably includes a control arrangement 21, which is provided particularly for controlling the second drive source 12. The second drive source 12 is, for example, an electric servo-motor with a spindle drive forming an electric linear drive arrangement, a hydraulic servo-drive or a drive provided with another type of travel control arrangement.

The control arrangement 21 may also be connected to angular position sensor 22 for the determination of the angular position of the gear 19 or, respectively, the eccentric member 18. In addition, or alternatively, the control arrangement 21 may be connected to a travel sensor 23 for determining the position of the plunger 6. Furthermore, the control arrangement 21 may be connected to the first drive source 11 for controlling the operation thereof. In addition, there may be an acceleration sensor 24 for determining the acceleration of the plunger 6 and/or the acceleration of the tool 4 and to report it to the control arrangement 21. Optionally, furthermore, one or more force sensors may be provided at the tool 4, the plunger 6, the link 17 or another part of the force transmission path from the drive source 11 to the tool 4 in order to determine the force applied by the tool 4 to the workpiece 5. Those sensors are then all also connected to the control arrangement 21.

The press described above operates as follows:

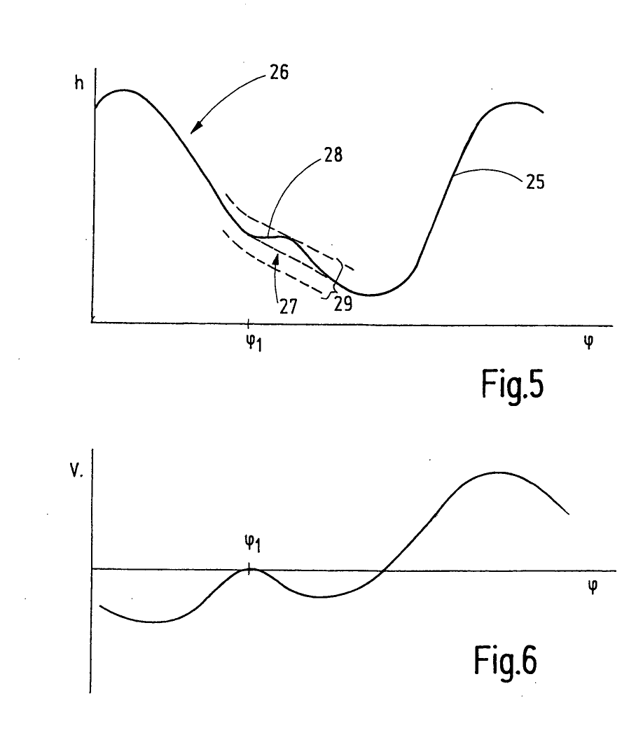

In FIG. 5, the curve 24 shows the relationship between the movement of the plunger 6 as height for dependence on the angle φ of the gear wheel 19. Angle φ is often called the “press angle”. The curve 25 is occasionally, but incorrectly, called the travel/time curve of the plunger movement which is justified only when the gear wheel 19 rotates essentially at constant speed. The plunger is moved following an about minus-shaped section 26 of the curve 25 up to a point where the lever drive 10 would, because of the kinematics follow a path shown in FIG. 5 as a dashed line 27. At the beginning of this section at a press angle φ1 the upper tool part 4 carries into contact with the workpiece 5. Shortly beyond this point, the second drive source is activated whereby the plunger movement is delayed. This is shown in FIG. 6 by the relationship between the press angle φ and the speed V of the plunger 6. The speed of the plunger 6 is at the press angle φ1 for a short period is zero or at least close to zero. In accordance therewith, the curve 25 shows in a section 28 a delay, that is a slow, smooth engagement of the upper tool part 4 with the workpiece 5. Subsequently, the plunger 6 is again accelerated, passes through the lower dead center position and returns to the upper dead center position.

The second drive source 12 is, for example, a servo-motor which operates in the section 28 of the curve 25 as a generator and feeds energy back into the power supply or into a flywheel storage device. Using this energy, the servo-motor can again be accelerated using the energy previously saved for the transforming of the workpiece 5.

The second drive source 12 includes an operating range 29 which is indicated in FIG. 5 by dashed lines and which is preferably smaller than the plunger stroke. It is, however, large enough to permit achieving the desired deformation of the curve 25, which results in the smooth engagement of the tool and the workpiece.

The control arrangement 21 can perform the process described above on the basis of a predetermined curve of movement provided for the second drive source 12. It is also possible to optimize the movement, for example, by leaving as the forces effective on the plunger 6 and/or the acceleration forces effective thereon are recorded. For example, this acceleration sensor 24 can be used to measure impulses as they occur upon contact of the upper tool 4 with the workpiece 5. The control arrangement 21 can then coordinate the operation resulting in the delay of the plunger movement timely in such a way that is, it can reduce or increase the speed of the plunger such that the impact of the plunger on the workpiece is minimized. This can be done during initial operation of the press or constantly during operation of the press in a continuing optimizing procedure.

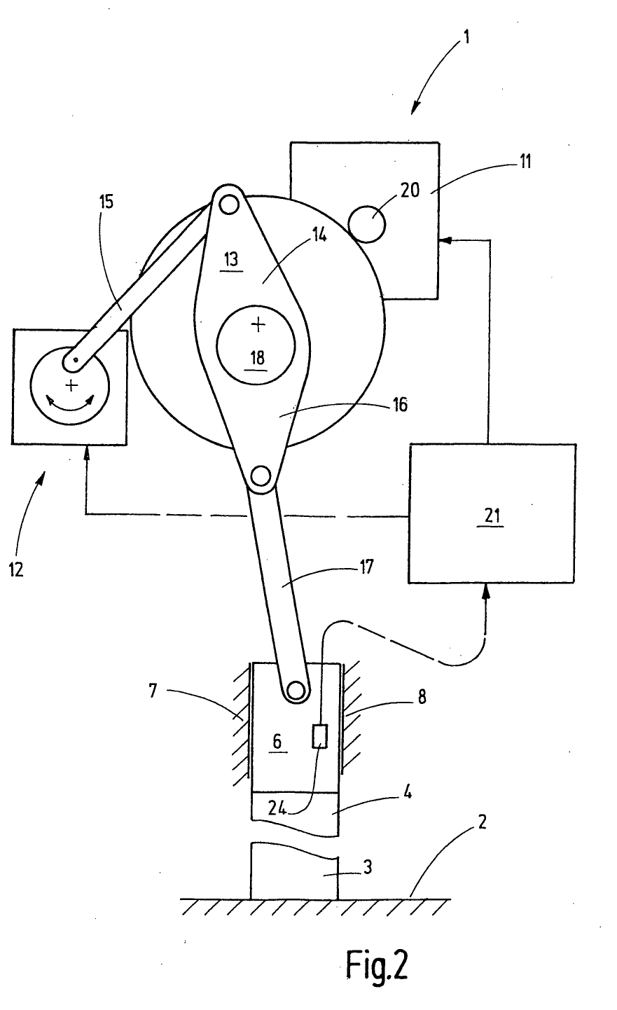

FIG. 2 shows a modified embodiment of the press according to the invention for which the above description applies also as the same reference numerals are used for functionally identical parts. Deviations are pointed out below:

The drive source 12 is in the form of an eccentric member drive, Whereas the drive 12 in accordance with FIG. 1 is a linear drive generating back and forth movements, the drive source 12 according to FIG. 2 can rotate forwardly and backwardly or in only one direction possibly with rotational accelerations and decelerations.

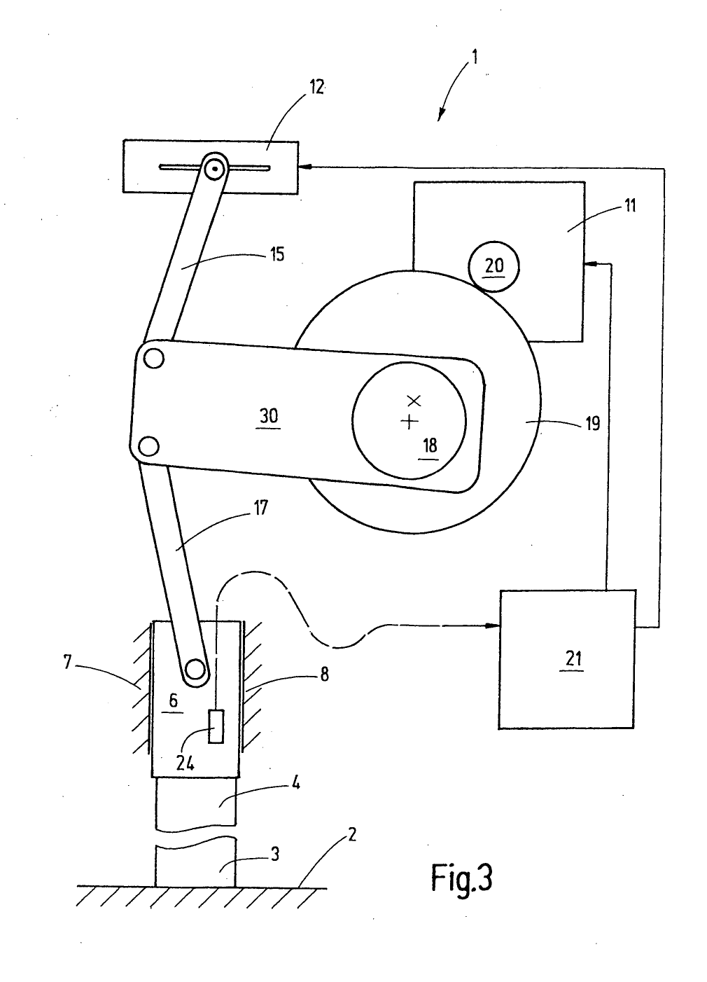

Another possible embodiment is shown in FIG. 3. Again the description of FIG. 1 applies based on the same reference numerals. Deviations are pointed out below.

In the press 1 shown in FIG. 3, a crank 30 is provided instead of the joint carrier 13 of FIGS. 1 and 2. And the two links 15, 17 are linked thereto at spaced pivot joints. The crank 30 is supported by the eccentric member 18. The link 15 is supported on a linear drive which forms the second drive source 12. The control arrangement 21 controls both drive sources 11, 12.

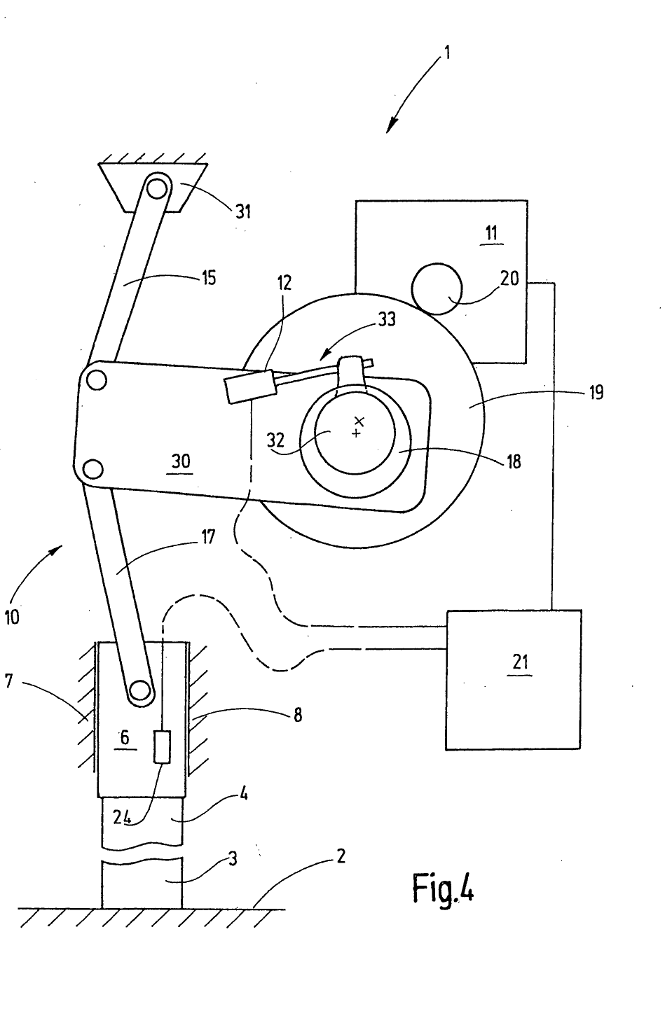

Another modified embodiment of the press 1, according to the invention, is shown in FIG. 4. Again the reference numerals correspond to those of FIGS. 1 and 2. Deviations are again pointed out below:

In the embodiment according to FIG. 4, the link 15 is linked to a fixed support structure 31. For influencing the curve 25 the gear wheel 19 is provided with an adjustable eccentric member 32 on which the drive eccentric member 18 is supported. Rotation of the adjustable eccentric member 32 changes the eccentricity of the eccentric member 18 which drives the crank 30. The adjustable eccentric member 32 is the second drive source 12 which is provided with a servo-motor which changes the angular position of the adjustable eccentric member 32 directly or by way of a spindle drive 33 or another drive means. Again the eccentric member 18 forms that first input and the adjustable eccentric member 32 forms the second input of the lever drive 10 whose output moves the plunger 6 via the link 17.

In addition, to the main drive source 11, a press 1 includes a second drive source 12 which can be used to dynamically control the press angle 1 plunger-stroke curve otherwise predetermined by the press kinematics. Particularly, a transformation process can be performed in this way, wherein the movable tool part of a transformation tool, engages the workpiece 5 at a speed of zero or almost zero, that is smoothly without sudden impact.

What is claimed is:

1. A press (1) with a travel-controllable drive arrangement, comprising:
a plunger (6) with a movable tool part (4) and being supported so as to be movable into, and out of engagement with workpiece (5);
a plunger drive (9) connected to the plunger (6) so as to move the plunger (6) in accordance with a selectable travel/time curve (26) and a drive arrangement (10) with a first drive input (18) and a second drive input (15a) as well as a drive output (17) connected to the plunger (6), said plunger drive (9) further comprising a first drive source (11) connected to the first drive input (18) and executing a continuous drive motion; and,
a second drive source (12) connected to the second drive input (15a) and performing a modulated drive movement over imposed on the first drive motion.

2. The press according to claim 1, wherein the plunger drive (9) is a lever drive.

3. The press according to claim 1, wherein the drive (9) includes an eccentric member forming the first drive input (18), a crank (30), a first link (17) connected between the crank (30) and the plunger (6) and a second link (15) which forms the second drive input (15a).

4. The press according to claim 1, wherein the drive (10) includes an eccentric member which forms the first drive input (18), a joint carrier (13), a first link (17) interconnecting the joint carrier (13) and the plunger (6) and a second link (15) which forms the second drive input (15a).

5. The press according to claim 1, wherein the first drive source (11) comprises a rotatable drive source.

6. The press according to claim 5, wherein the rotatable drive source includes a flywheel.

7. The press according to claim 1, wherein the second drive source (12) is a linear drive.

8. The press according to claim 7, wherein the linear drive is an electric drive.

9. The press according to claim 7, wherein the linear drive is a hydraulic drive.

10. The press according to claim 1, wherein a control unit (21) is provided for controlling the second drive source (12) in such a way that the engagement speed of the tool piece 4 when engaging the workpiece (5) is zero.

11. The press according to claim 10, wherein control unit (21) controls the engagement speed of the tool piece (4) to be adjustable to the value zero or similar predetermined value.

12. A press according to claim 10, wherein control unit (21) controls the engagement speed to be controllable to a desired value.

13. The press according to claim 10, wherein control unit (21) controls the second drive source (12) depending on the position of one of the first drive source (11) and the plunger (6).

14. The press according to claim 10, wherein control unit (21) controls the second drive source (12) based on a predetermined profile.

15. The press according to claim 14, wherein the predetermined profile is set on the basis of an acceleration value.

16. The press according to claim 14, wherein an acceleration sensor (24) is provided sensing the acceleration values at the plunger (6) or the tool part (3, 4).

17. A method for transforming a workpiece (5) wherein a movable tool part (4) is retracted before its engagement with the workpiece (5) and is then again accelerated.

18. The method according to claim 17, wherein a plunger (6) is decelerated during the closing movement of the tool part (3, 4) in such a way that the movable tool part (4) assures a speed of zero upon engagement of the workpiece (5).
